(19) United States
(12) Patent Application Publication
(10) Pub. No.: US 2024/0028410 A1
(43) Pub. Date: Jan. 25, 2024

(54) RESOURCE LIMIT(S) FOR EXECUTION OF AN EXECUTABLE PROGRAM ON AN EXECUTION PLATFORM BASED ON AN ATTRIBUTE(S) OF AN INPUT(S) ON WHICH THE EXECUTABLE PROGRAM IS EXECUTED

(71) Applicant: Shopify Inc., Ottawa (CA)

(72) Inventor: Steven MacLeod, Hamilton (CA)

(21) Appl. No.: 17/814,360

(22) Filed: Jul. 22, 2022

(51) Int. Cl. G06F 9/50

(52) U.S. Cl. CPC G06F 9/5055

(57) ABSTRACT

Systems and methods are disclosed for limiting the amount of resources consumed by execution of an executable program on an execution platform based on an attribute(s) of an input(s) on which the executable program is executed. In one embodiment, a computer-implemented method comprises receiving a request to execute an executable program on an input(s), determining an attribute(s) of the input(s), determining a resource limit(s) for execution of the executable program based on the attribute(s) of the input(s), and executing the executable program on the input(s). The method further comprises, while executing the executable program, monitoring resource usage of the executable program and determining that at least one of the resource limit(s) has been reached or exceeded, based on the monitored resource usage, and performing an action(s) responsive thereto.

### TECHNICAL FIELD

The present disclosure relates to limiting resource consumption of an executable program on an execution platform.

### BACKGROUND

Platforms for hosting e-commerce stores (e.g., the Shopify® platform) enable individual people and businesses to quickly and easily create, operate, and manage their own e-commerce stores. In this regard, there is a desire to enable such platforms to allow business owners and operators to provide customized functionality and features. However, due to the enormous number of businesses and types of businesses, providing such customized functionality and features is a challenging task from the perspective of the operator of the hosting platform.

### SUMMARY

There is a desire to allow third-party developers to provide executable programs for execution on an operator's physical or virtual machine. For example, an e-commerce store may be hosted via an e-commerce store hosting platform such as the Shopify® platform, where the platform may desire to enable third parties (e.g., merchants) to develop their own executable programs (e.g., scripts or WebAssembly programs) to enable merchant-specific functionality. However, allowing this creates problems in that poorly designed executable programs and/or malicious executable programs may consume too much of the resources of the operator's physical or virtual machine.

One naïve solution is to set hard resource limits (e.g., hard execution time and memory limits) for such third-party applications. However, such hard resource limits may result in one or more of the following problems. Hard resource limits may prevent legitimate third-party programs from being executed because these programs exceed the hard resource limits. Hard resource limits may also allow inefficient programs that do not exceed the hard limits to nevertheless execute, even though such inefficient programs are consuming more resources than needed. A large number of such programs (or executing such programs a large number of times) would result in a significant amount of resources being consumed unnecessarily. Lastly, hard resource limits may allow unwanted programs that do not exceed the hard resource limits to execute even though such programs may be performing unwanted activities.

Thus, there is a need for systems and methods for preventing execution of programs that are inefficient or perform unwanted activities and, as such, result in unwanted consumption of resources of the execution platform.

Systems and methods are disclosed for limiting the amount of resources consumed by execution of an executable program on an execution platform based on one or more resource limits that are determined based on one or more attributes of one or more inputs on which the executable program is executed. In one embodiment, a computer-implemented method comprises receiving, by an execution platform, a request to execute an executable program on one or more inputs and determining, by the execution platform, one or more attributes of the one or more inputs. The method further comprises determining, by the execution platform, one or more resource limits for execution of the executable program based on the one or more attributes of the one or more inputs and executing, by the execution platform, the executable program on the one or more inputs. The method further comprises, while executing the executable program, monitoring, by the execution platform, resource usage of the executable program and determining, by the execution platform, that at least one of the one or more resource limits for execution of the executable program has been reached or exceeded, based on the monitored resource usage. The method further comprises performing, by the execution platform, one or more actions responsive to determining that at least one of the one or more resource limits for execution of the executable program has been reached or exceeded. In this manner, a resource limit(s) for an executable program can be determined in a flexible manner based on an attribute(s) of the input(s) on which the executable program is executed.

In one embodiment, the executable program comprises: (a) a serverless function, (b) a WebAssembly serverless function, (c) a WebAssembly program, (d) a binary executable computer program, (e) an Executable (EXE) program or an Application (APP) program, (f) a script program, or (g) a combination of any two or more of (a)-(f).

In one embodiment, the execution platform is a virtualization platform comprising a virtual machine that executes the executable program. In another embodiment, the execution platform is a physical machine.

In one embodiment, the one or more attributes of the one or more inputs comprise a size of the one or more inputs. In one embodiment, the one or more inputs comprise: (a) input data, wherein the size of the one or more inputs comprises a size of input data in terms of a number of bytes, (b) one or more input arrays, wherein the size of the one or more inputs comprises either a number of elements comprised in a largest input array from among the one or more input arrays or a total number of elements comprised in all of the one or more input arrays, (c) one or more input arrays, wherein the size of the one or more inputs comprises a total data size of all data comprised in all elements of the one or more input arrays, (d) one or more input data trees, wherein the size of the one or more inputs comprises a number of nodes in an input data tree, a data size of one of the nodes in the input data tree having a largest data size from among all nodes in the input data tree, or a total data size of all data comprised in all nodes of the input data tree, or (e) a combination of any two or more of (a)-(d).

In one embodiment, the one or more attributes of the one or more inputs comprise an input type of the one or more inputs.

In one embodiment, determining the one or more resource limits for execution of the executable program based on the one or more attributes of the one or more inputs comprises scaling one or more respective default resource limits based on the one or more attributes of the one or more inputs to thereby provide the one or more resource limits for execution of the executable program. In one embodiment, scaling the one or more respective default resource limits based on the one or more attributes of the one or more inputs comprises scaling the one or more respective default resource limits based on the one or more attributes of the one or more inputs and one or more linear scaling factors. In one embodiment, the one or more resource limits comprise two or more resource limits associated to either: (a) two or more different linear scaling factors or (b) the same linear scaling factor. In another embodiment, scaling the one or more respective default resource limits based on the one or more attributes of the one or more inputs comprises non-linearly scaling the one or more respective default resource limits based on the one or more attributes of the one or more inputs and a defined or configured non-linear function.

In one embodiment, performing the one or more actions responsive to determining that the at least one of the one or more resource limits for execution of the executable program has been reached or exceeded comprises: (a) terminating execution of the executable program, (b) notifying an operator of the execution platform that execution of the executable program on the one or more inputs exceeded the at least one of the one or more resource limits, (c) notifying a developer of the executable program that execution of the executable program on the one or more inputs exceeded the at least one of the one or more resource limits, (d) notifying an associated end-user that execution of the executable program on the one or more inputs exceeded the at least one of the one or more resource limits, (e) notifying the associated end-user of one or more impacts on a user experience of the associated end-user that result from termination of the execution of the executable program, or (f) a combination of any two or more of (a)-(e).

Corresponding embodiments of a computing system for hosting an execution platform are also disclosed. In one embodiment, the computing system comprises processing circuitry configured to cause the computing system to receive a request to execute an executable program on one or more inputs, determine one or more attributes of the one or more inputs, determine one or more resource limits for execution of the executable program based on the one or more attributes of the one or more inputs, and execute the executable program on the one or more inputs. The processing circuitry is further configured to cause the computing system to, while executing the executable program, monitor resource usage of the executable program, determine that at least one of the one or more resource limits for execution of the executable program has been reached or exceeded based on the monitored resource usage, and perform one or more actions responsive to determining that the at least one of the one or more resource limits for execution of the executable program has been reached or exceeded.

Corresponding embodiments of a non-transitory computer readable medium are also disclosed. In one embodiment, the non-transitory computer readable medium comprises software instructions that, when executed by processing circuitry of an execution platform, cause the execution platform to receive a request to execute an executable program on one or more inputs, determine one or more attributes of the one or more inputs, determine one or more resource limits for execution of the executable program based on the one or more attributes of the one or more inputs, and execute the executable program on the one or more inputs. When executed by the processing circuitry of the execution platform, the software instructions further cause the execution platform to, while executing the executable program, monitor resource usage of the executable program, determine that at least one of the one or more resource limits for execution of the executable program has been reached or exceeded based on the monitored resource usage, and perform one or more actions responsive to determining that the at least one of the one or more resource limits for execution of the executable program has been reached or exceeded.

### BRIEF DESCRIPTION OF THE DRAWINGS

The accompanying drawings figures incorporated in and forming a part of this specification illustrate several aspects of the disclosure, and together with the description server to explain the principles of the disclosure.

FIG. 1 illustrates one example of an execution platform in which embodiments of the present disclosure may be implemented;

FIG. 2 is a flow chart that illustrates the operation of an execution platform in accordance with embodiments of the present disclosure; platform;

FIG. 3 is a schematic block diagram of an example embodiment of an execution platform;

FIG. 4 illustrates an example e-commerce platform, according to one embodiment of the present disclosure; and

FIG. 5 depicts a non-limiting embodiment for a home page of an administrator.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note that, as used herein, the term “comprising” (and other forms of the word “comprise”) is which is synonymous with “including,” “containing,” or “characterized by,” and is inclusive or open-ended and does not exclude additional, unrecited elements or steps. Conversely, the term “consisting of” (and other related forms) is synonymous with “including,” “containing,” or “characterized by,” but is exclusive in that it excludes additional, unrecited elements or steps.

Systems and methods are disclosed that relate to determining one or more resource limits for an executable program based on one or more attributes of one or more inputs to the executable program and imposing the one or more determined resource limits. As used herein, an “executable program” is any computer program that can be executed by an execution platform, where an “execution platform” is a physical computing system or a virtualization platform including a virtual machine on which the executable program is to be run. A physical computing system is any system comprising processing circuitry and memory storing executable instructions (e.g., software) that, when executed by the processing circuitry, causes the system to provide the functionality of the execution platform described herein. Some examples of a physical computing system include a personal computer, a physical server computer, a tablet computer, a smartphone, or the like. Note, however, that in a preferred embodiment, the execution platform is a physical server computer or similar platform that executes third-party applications but is to be distinguished from a user's personal computer that executes an application (e.g., an application licensed from a third-party). The executable program may be any type of executable program such as, e.g., a stateful executable program, a stateless executable program, a read-only executable program, a read and write (read/write) executable program, an executable program that requires access to third-party data and/or third-party servers, or the like. For example, the executable program may be a binary executable computer program (e.g., a serverless function, a WebAssembly serverless function, a WebAssembly program for a stack-based virtual machine, an Executable (EXE) program for a physical or virtual Microsoft Windows machine, or an Application (APP) program for a physical or virtual MacOS machine), or a script program such as, e.g., a JavaScript program, a Hypertext Preprocessor (PHP) script, a Ruby script, a Python script, or the like, or any combination thereof. However, in one preferred embodiment, the executable program is a WebAssembly program, a script program, a serverless function, or a WebAssembly serverless function. Further, while the executable program may be of one form (e.g., serverless function, WebAssembly serverless function, WebAssembly program, etc.), the executable program may alternatively be of a mixed form (e.g., a binary executable program that also calls methods or functions implemented by or on top of a virtual machine).

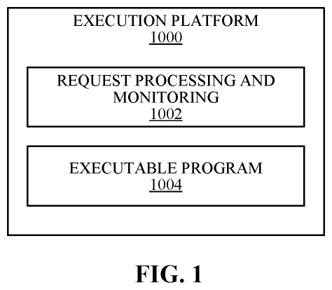

In this regard, FIG. 1 illustrates an execution platform 1000 in accordance with one embodiment of the present disclosure. As illustrated, the execution platform 1000 includes a request processing and monitoring function 1002, which is preferably implemented in software executed by processing circuitry (not shown) of the execution platform 1000. The execution platform 1000 also stores an executable program 1004. Note that while only one executable program 1004 is shown for clarity and ease of discussion, it should be appreciated that the execution platform 1000 may store many (e.g., 10s, 100s, 1000s, or more) executable programs.

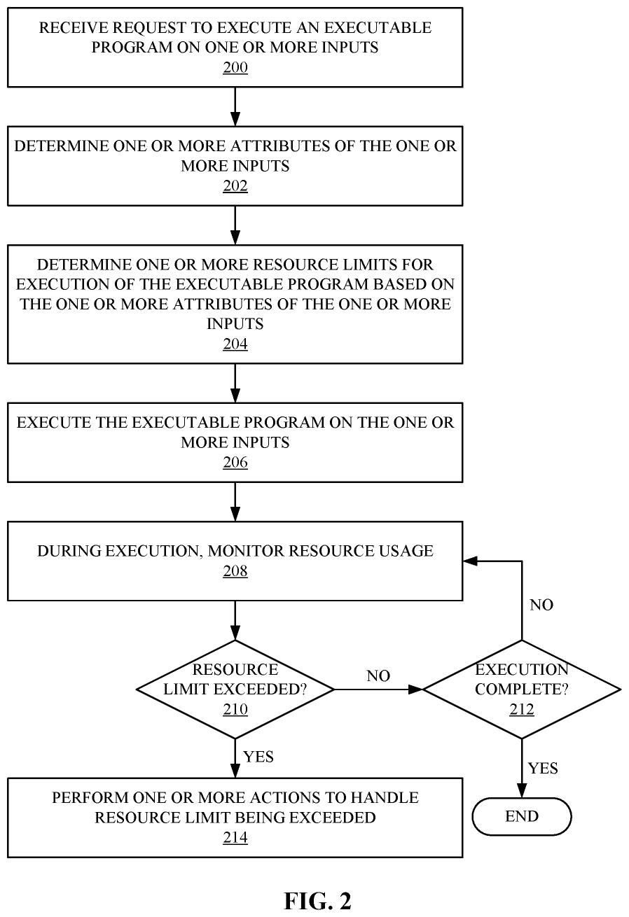

FIG. 2 is a flow chart that illustrates the operation of the execution platform 1000 in accordance with embodiments of the present disclosure. As illustrated, the execution platform 1000, and more specifically the request processing and monitoring function 1002, receives a request to execute, or run, an executable program 1004 on one or more inputs (step 200). In one embodiment, the request includes the one or more inputs or a reference to the one or more inputs (e.g., a reference to data corresponding to the one or more inputs where this data is stored in the memory of the execution platform 1000, stored by a local or remote database, or the like). Further, in some cases, the one or more inputs may be data that is streamed to the execution platform 1000 from a remote source. The request to execute the executable program 1004 on the one or more inputs may be received from an internal source within the execution platform 1000 (e.g., received from another executable program executing on the execution platform 1000) or may be received from an external source (e.g., received from an external server or computer). For example, in an e-commerce scenario, the execution platform 1000 may be a physical or virtual machine that hosts a web-based e-commerce website for a merchant, the executable program 1004 may be an executable program provided by a third party such as the merchant or may be an executable program provided by an operator of the physical or virtual machine, and the one or more inputs may be any input(s) associated to an e-commerce transaction between the merchant and a customer (e.g., an array of items in a shopping cart of the customer). In one preferred embodiment, the executable program 1004 is a third-party executable program (i.e., the executable program is provided by an entity other than an operator of the execution platform).

The execution platform 1000, and more specifically the request processing and monitoring function 1002, determines one or more attributes of the one or more inputs on which the executable program 1004 is to be run (step 202) and determines one or more resource limits for the executable program 1004 based on the one or more attributes of the one or more inputs on which the executable program 1004 is to be run (step 204). In one embodiment, the one or more resource limits for the executable program 1004 are determined based on the one or more attributes of the one or more inputs on which the executable program 1004 is to be run by scaling one or more respective default resource limits, where these default resource limits are predefined or configured.

The one or more resource limits include one or more limits on one or more types of resources associated to the execution platform 1000 on which the executable program 1004 is executed. The one or more resource limits may include, for example, a limit on an amount of processing resources (e.g., Central Processing Unit (CPU) cycles, CPU instructions, processing time, or the like) that can be utilized for execution of the executable program 1004, a limit on an amount of memory (e.g., stack, heap) that can be utilized for execution of the executable program 1004, a limit on a wall-clock time for execution of the executable program 1004, or the like. Note that “wall-clock time” is the amount of time that has elapsed since the start of execution of the executable program 1004. In contrast, “processing time” is the aggregate amount of time during which CPU resources of the execution platform 1000 are consumed for execution of the executable program 1004, which excludes time spent by the execution platform 1000 executing one or more other executable programs in parallel with the executable program 1004 and time spent by the execution platform 1000 requesting and waiting for data or input from another entity (e.g., waiting for input from a user, waiting on data to be returned from a server, waiting on some other called function to respond to a request, or the like). More generally, certain resource consumption may be excluded from the one or more resource limits. For example, in one embodiment, resources consumed due to any call(s) or request(s) to another entity (or entities) may be excluded from the one or more resource limits.

The one or more resource limits for the executable program 1004 are determined based on the one or more attributes of one or more inputs to the executable program 1004. For example, in one embodiment, the one or more resource limits are determined based on a size of the one or more inputs. The “size” of the one or more inputs may be, for example:
a total size of data input to the executable program 1004 in number of bytes,
if the one or more inputs include an input array (e.g., an array of items to be added to a user's shopping cart), the size of the input array in terms of the number of elements in the input array,
if the one or more inputs include multiple input arrays, the size of a largest input array from among the multiple input arrays in terms of the number of elements in the largest input array,
if the one or more inputs include multiple input arrays, the total number of elements in all of the multiple input arrays,
if the one or more inputs include one or more input arrays, a largest data size of data contained in an element in any of the one or more input arrays or a combined data size of all elements in the one or more input arrays,
if the one or more inputs include input data in the form of a tree structure (referred to here as an “input data tree”), the size of the tree structure in terms of the number of nodes in the tree structure, or
if the one or more inputs include input data in the form of a tree structure, a largest data size of data contained in any node of the tree structure or a combined data size of the data in all nodes in the tree structure.
   Note that, as will be understood by one of ordinary skill in the art, a data tree structure (also called a tree data structure) is a type of hierarchical data structure arranged in a tree-like structure having a central node and sub-nodes connected via edges.

Note that the size of the one or more inputs is only one example of an attribute of the one or more inputs that can be used to determine the one or more resource limits. The one or more resource limits may be determined based on additional or alternative attributes of the one or more inputs such as, e.g., any one or more of the following:
an input type of the one or more inputs (e.g., input array, input tree structure, alpha-numeric text, image, audio, video, etc.),
whether the one or more inputs are compressed and what compression algorithm(s) is(are) used,
whether the one or more inputs are encrypted and what encryption algorithm(s) is(are) used,
whether the one or more inputs contain repeated entries or sequences, how many, and of what length,
whether the executable has processed an identical input(s) in the past,
whether the one or more inputs contain untrusted data provided by a third party,
the encoding of the one or more inputs (ASCII, utf-8, etc.).
the size of the difference between the input(s) and a previous, or standard, input(s) (i.e. if an algorithm is applied to the input to determine the difference between it and another input, what is the size of the result difference),
the source of the one or more inputs (e.g., an internal system versus the author of the executable versus a customer of the online store, etc.).

In one embodiment, the one or more resource limits are determined by scaling one or more respective default resource limits based on the one or more attributes of the one or more inputs to the executable program 1004. This scaling may be performed in any desired manner. For example, in one embodiment, the one or more default resource limits are linearly scaled based on the one or more attributes of the one or more inputs to the executable program 1004 to thereby provide the one or more determined resource limits. For instance, one or more linear scaling factors may be predefined or configured. If multiple inputs or input attributes are used, different scaling factors may be used for different inputs or different input attributes (e.g., scaling a first default resource limit based on the one or more attributes for the one or more inputs and a first scaling factor, scaling a second default resource limit based on the one or more attributes of the one or more inputs and a second scaling factor that is different than the first scaling factor, etc.) or the same scaling factor may be used for multiple (e.g., all) inputs or multiple (e.g., all) input attributes (e.g., scaling a first default resource limit based on the one or more attributes for the one or more inputs and a scaling factor, scaling a second default resource limit based on the one or more attributes of the one or more inputs and the same scaling factor, etc.). Likewise, if multiple resource limits are scaled, different linear scaling factors may be used for different resource limits or the same linear scaling factor may be used for multiple (e.g., all) resource limits.

In another embodiment, the scaling is non-linear. In other words, the one or more default resource limits are scaled as a predefined or configured non-linear function of the one or more inputs or the one or more attributes of the one or more inputs to thereby provide the one or more determined resource limits. The predefined or configured non-linear function can be any type of non-linear function such as, e.g., a logarithmic function. As an example, in one embodiment:
if the one or more inputs or the one or more attributes of the one or more inputs satisfy one or more first criteria (e.g., size is greater than a predefined or configured threshold), then the one or more default resource limits are scaled (e.g., linearly based on one or more linear scaling factors or non-linearly based on a predefined or configured non-linear function) to provide the one or more determined resource limits; and
if the one or more inputs or the one or more attributes of the one or more inputs satisfy one or more second criteria (e.g., size is less than a predefined or configured threshold), then the one or more default resource limits are not scaled (i.e., the one or more determined resource limits are the one or more default resource limits).

In one embodiment, whether the scaling is linear or non-linear, at least one of the one or more resource limits has a predefined or configured maximum resource limit. In this case, the resource limit is scaled up to the maximum resource limit but cannot be scaled above the maximum resource limit.

In one embodiment, if there are multiple resource limits being determined, the determining (e.g., scaling) may be done in such a manner that the value of at least one of the multiple resource limits is dependent on the value of at least one other of the multiple resource limits. For example, an increase in one resource limit may result in a decrease in another resource limit.

Once the one or more resource limits are determined, the execution platform 1000 then executes the executable program 1004 on the one or more inputs (step 206). While the executable program 1004 is executing, the execution platform 1000, and more specifically the request processing and monitoring function 1002, monitors resources consumed by the executable program 1004 during execution (step 208). Based on the monitoring, the execution platform 1000, and more specifically the request processing and monitoring function 1002, determines whether the executable program 1004 has reached any of the one or more determined resource limits during execution (step 210). If not (step 210, NO), the request processing and monitoring function 1002 determines whether execution of the executable program 1004 is complete (step 212). If so (step 212, YES), the procedure ends; otherwise (step 212, NO), the request processing and monitoring function 1002 returns to monitoring (step 208).

Returning to step 210, if any of the one or more determined resource limits is reached before execution has completed (step 210, YES), the execution platform 1000, and more specifically the request processing and monitoring function 1002, performs one or more actions to handle the executable program 1000 reaching any of the one or more determined resource limits (step 214). For example, the request processing and monitoring function 1002 may terminate execution of the executable program 1004. In addition, the request processing and monitoring function 1002 may provide a report to an operator of the execution platform 1000 and/or provide one or more messages to a developer of the executable program 1004 that provides information about the termination of execution of the executable program 1004 (e.g., information about why execution was executed, information about the input(s) that resulted in the termination of execution, or the like). In addition or alternatively, in the context of an e-commerce transaction, the request processing and monitoring function 1002 may provide or trigger an error message or notification to the end-user (e.g., the customer), where this error message or notification may, e.g., inform the end-user about how the end-user is impacted by termination of the execution of the executable program 1004 (e.g., a message that says that some respective operation has failed but the items remain in the customer's shopping cart).

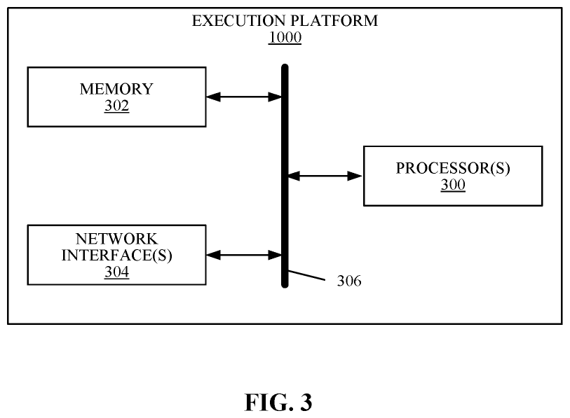

FIG. 3 is a schematic block diagram of one example embodiment of the execution platform 1000 in which embodiments of the present disclosure may be implemented. As illustrated, the execution platform 1000 includes one or more processors 300 (e.g., CPUs, Application Specific Integrated Circuits (ASICs), Field Programmable Gate Arrays (FPGAs), and/or the like), memory 302, and one or more network interfaces 304 (e.g., a Wi-Fi network interface, a cellular (e.g., Fifth Generation (5G)) interface, an Ethernet network interface, or the like), connected via a bus 306 or the like. The processors 300 are also referred to herein as processing circuitry. In some embodiments, the request processing and monitoring function 1002 and the executable program 1004 described above are implemented in software that is stored in the memory 302 and executed by the processor(s) 300. Note that the execution platform 1000 may include additional components not illustrated in FIG. 3 such as, e.g., a power supply (e.g., a battery and associated power circuitry), etc.

In some embodiments, a computer program including instructions which, when executed by at least one processor, causes the at least one processor to carry out the functionality of the execution platform 1000, the request processing and monitoring function 1002, and/or the executable program 1004 according to any of the embodiments described herein is provided. In some embodiments, a carrier comprising the aforementioned computer program product is provided. The carrier is one of an electronic signal, an optical signal, a radio signal, or a computer-readable storage medium (e.g., a non-transitory computer-readable medium such as memory).

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

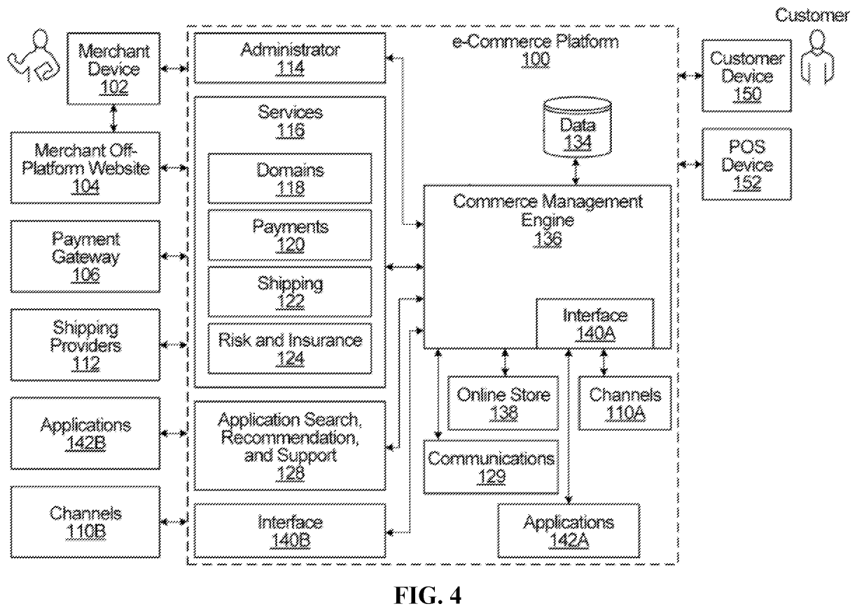

FIG. 4 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 4, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

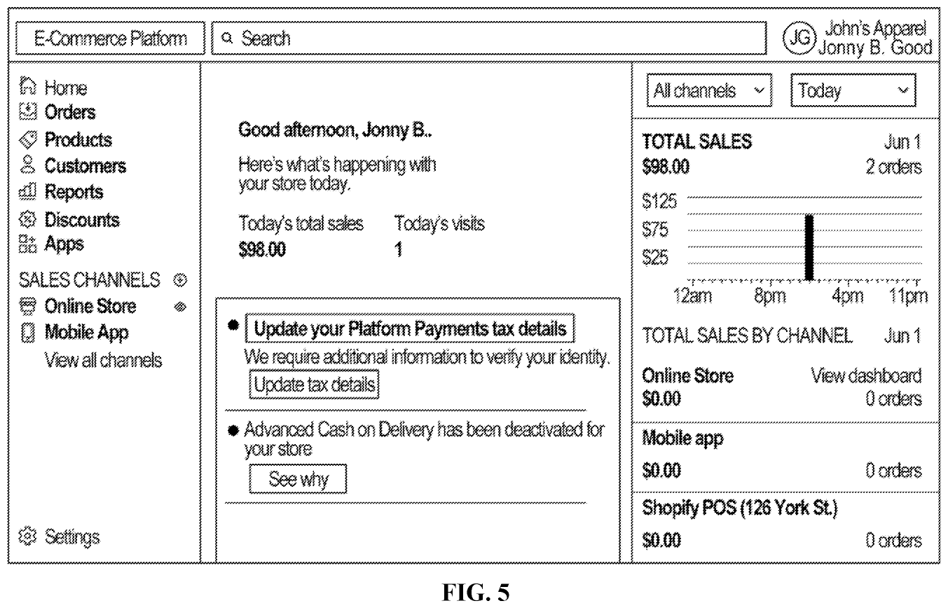

FIG. 5 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 5. Sections of the administrator 114 may include various interfaces for accessing and managing core aspects of a merchant's business, including orders, products, customers, available reports, and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 4, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation, and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

It should be noted that, in one example embodiment, the execution platform 1000 is or is implemented as part of the e-commerce platform 100. In this manner, e-commerce platform 100 may use the process of FIG. 2 to limit the amount of resources consumed by execution of an executable program on the e-commerce platform 100 based on one or more resource limits that are determined based on one or more attributes of one or more inputs on which the executable program is executed, as described herein.

Those skilled in the art will recognize improvements and modifications to the embodiments of the present disclosure. All such improvements and modifications are considered within the scope of the concepts disclosed herein.

1. A computer-implemented method, comprising:
receiving, by an execution platform, a request to execute an executable program on one or more inputs;
determining, by the execution platform, one or more attributes of the one or more inputs;
determining, by the execution platform, one or more resource limits for execution of the executable program based on the one or more attributes of the one or more inputs;
executing, by the execution platform, the executable program on the one or more inputs; and
while executing the executable program:
monitoring, by the execution platform, resource usage of the executable program;
determining, by the execution platform, that at least one of the one or more resource limits for execution of the executable program has been reached or exceeded, based on the monitored resource usage; and
performing, by the execution platform, one or more actions responsive to determining that the at least one of the one or more resource limits for execution of the executable program has been reached or exceeded.

2. The method of claim 1 wherein the executable program comprises:
a serverless function;
a WebAssembly serverless function;
a WebAssembly program;
a binary executable computer program;
an Executable (EXE) program or an Application (APP) program;
a script program; or
a combination of any two or more thereof.

3. The method of claim 1 wherein the execution platform is a virtualization platform comprising a virtual machine that executes the executable program.

4. The method of claim 1 wherein the execution platform is a physical machine.

5. The method of any of claims 1 wherein the one or more attributes of the one or more inputs comprise a size of the one or more inputs.

6. The method of claim 5 wherein the one or more inputs comprise:
input data, wherein the size of the one or more inputs comprises a size of input data in terms of a number of bytes;
one or more input arrays, wherein the size of the one or more inputs comprises either a number of elements comprised in a largest input array from among the one or more input arrays or a total number of elements comprised in all of the one or more input arrays;
one or more input arrays, wherein the size of the one or more inputs comprises a total data size of all data comprised in all elements of the one or more input arrays;
one or more input data trees, wherein the size of the one or more inputs comprises a number of nodes in an input data tree, a data size of one of the nodes in the input data tree having a largest data size from among all nodes in the input data tree, or a total data size of all data comprised in all nodes of the input data tree; or
a combination of any two or more thereof.

7. The method of claim 1 wherein the one or more attributes of the one or more inputs comprise an input type of the one or more inputs.

8. The method of claim 1 wherein determining the one or more resource limits for execution of the executable program based on the one or more attributes of the one or more inputs comprises scaling one or more respective default resource limits based on the one or more attributes of the one or more inputs to thereby provide the one or more resource limits for execution of the executable program.

9. The method of claim 8 wherein scaling the one or more respective default resource limits based on the one or more attributes of the one or more inputs comprises scaling the one or more respective default resource limits based on the one or more attributes of the one or more inputs and one or more linear scaling factors.

10. The method of claim 9 wherein the one or more resource limits comprise two or more resource limits associated to either: (a) two or more different linear scaling factors or (b) the same linear scaling factor.

11. The method of claim 8 wherein scaling the one or more respective default resource limits based on the one or more attributes of the one or more inputs comprises non-linearly scaling the one or more respective default resource limits based on the one or more attributes of the one or more inputs and a defined or configured non-linear function.

12. The method of claim 1 wherein performing the one or more actions responsive to determining that the at least one of the one or more resource limits for execution of the executable program has been reached or exceeded comprises:
terminating execution of the executable program;
notifying an operator of the execution platform that execution of the executable program on the one or more inputs exceeded the at least one of the one or more resource limits;
notifying a developer of the executable program that execution of the executable program on the one or more inputs exceeded the at least one of the one or more resource limits;
notifying an associated end-user that execution of the executable program on the one or more inputs exceeded the at least one of the one or more resource limits;
notifying the associated end-user of one or more impacts on a user experience of the associated end-user that result from termination of the execution of the executable program; or
a combination of any two or more thereof.

13. A computing system for hosting an execution platform, the computing system comprising processing circuitry configured to cause the computing system to:
receive, by the execution platform, a request to execute an executable program on one or more inputs;
determine by the execution platform, one or more attributes of the one or more inputs;
determine, by the execution platform, one or more resource limits for execution of the executable program based on the one or more attributes of the one or more inputs;
execute, by the execution platform, the executable program on the one or more inputs; and
while executing the executable program:
monitor, by the execution platform, resource usage of the executable program;
determine, by the execution platform, that at least one of the one or more resource limits for execution of the executable program has been reached or exceeded, based on the monitored resource usage; and
perform, by the execution platform, one or more actions responsive to determining that the at least one of the one or more resource limits for execution of the executable program has been reached or exceeded.

14. A non-transitory computer readable medium comprising software instructions that when executed by processing circuitry of an execution platform cause the execution platform to:
receive a request to execute an executable program on one or more inputs;
determine one or more attributes of the one or more inputs;
determine one or more resource limits for execution of the executable program based on the one or more attributes of the one or more inputs;
execute the executable program on the one or more inputs; and
while executing the executable program:
monitor resource usage of the executable program;
determine that at least one of the one or more resource limits for execution of the executable program has been reached or exceeded, based on the monitored resource usage; and
perform one or more actions responsive to determining that the at least one of the one or more resource limits for execution of the executable program has been reached or exceeded.

15. The non-transitory computer readable medium of claim 14 wherein the executable program comprises:
a serverless function;
a WebAssembly serverless function;
a WebAssembly program;
a binary executable computer program;
an Executable (EXE) program or an Application (APP) program;
a script program; or
a combination of any two or more thereof.

16. The non-transitory computer readable medium of claim 14 wherein the execution platform is a virtualization platform comprising a virtual machine that executes the executable program.

17. The non-transitory computer readable medium of claim 14 wherein the execution platform is a physical machine.

18. The non-transitory computer readable medium of claim 14 wherein the one or more attributes of the one or more inputs comprise a size of the one or more inputs.

19. The non-transitory computer readable medium of claim 18 wherein the one or more inputs comprise:
input data, wherein the size of the one or more inputs comprises a size of input data in terms of a number of bytes;
one or more input arrays, wherein the size of the one or more inputs comprises either a number of elements comprised in a largest input array from among the one or more input arrays or a total number of elements comprised in all of the one or more input arrays;
one or more input arrays, wherein the size of the one or more inputs comprises a total data size of all data comprised in all elements of the one or more input arrays;
one or more input data trees, wherein the size of the one or more inputs comprises a number of nodes in an input data tree, a data size of one of the nodes in the input data tree having a largest data size from among all nodes in the input data tree, or a total data size of all data comprised in all nodes of the input data tree; or
a combination of any two or more thereof.

20. The non-transitory computer readable medium of claim 14 wherein the one or more attributes of the one or more inputs comprise an input type of the one or more inputs.

21. The non-transitory computer readable medium of claim 14 wherein the one or more resource limits for execution of the executable program are determined based on the one or more attributes of the one or more inputs by scaling one or more respective default resource limits based on the one or more attributes of the one or more inputs to thereby provide the one or more resource limits for execution of the executable program.

22. The non-transitory computer readable medium of claim 21 wherein scaling the one or more respective default resource limits based on the one or more attributes of the one or more inputs comprises scaling the one or more respective default resource limits based on the one or more attributes of the one or more inputs and one or more linear scaling factors.

23. The non-transitory computer readable medium of claim 22 wherein the one or more resource limits comprise two or more resource limits associated to either: (a) two or more different linear scaling factors or (b) the same linear scaling factor.

24. The non-transitory computer readable medium of claim 21 wherein scaling the one or more respective default resource limits based on the one or more attributes of the one or more inputs comprises non-linearly scaling the one or more respective default resource limits based on the one or more attributes of the one or more inputs and a defined or configured non-linear function.

25. The non-transitory computer readable medium of claim 14 wherein the one or more actions comprise:
terminating execution of the executable program;
notifying an operator of the execution platform that execution of the executable program on the one or more inputs exceeded the at least one of the one or more resource limits;
notifying a developer of the executable program that execution of the executable program on the one or more inputs exceeded the at least one of the one or more resource limits;
notifying an associated end-user that execution of the executable program on the one or more inputs exceeded the at least one of the one or more resource limits;
notifying the associated end-user of one or more impacts on a user experience of the associated end-user that result from termination of the execution of the executable program; or
a combination of any two or more thereof.
